(19) United States
(12) Patent Application Publication
(10) Pub. No.: US 2015/0293530 A1
(43) Pub. Date: Oct. 15, 2015

(54) MANUFACTURING EXECUTION SYSTEM AUTHORIZATION

(71) Applicant: Invensys Systems, Inc., Foxboro, MA (US)

(72) Inventors: Adam R. Haskell, Lake Forest, CA (US); Anton K. Popov, Lake Forest, CA (US); James E. O'Hearn, Mission Viejo, CA (US)

(73) Assignee: Invensys Systems, Inc., Foxboro, MA (US)

(21) Appl. No.: 14/748,412

(22) Filed: Jun. 24, 2015

Related U.S. Application Data
(63) Continuation-in-part of application No. 14/194,151, filed on Feb. 28, 2014.

(51) Int. Cl. G05B 19/418

(52) U.S. Cl. CPC G05B 19/41885; G05B 2219/35204

(57) ABSTRACT

A manufacturing execution system (MES) for selectively controlling the display of MES content. The MES displays a first view with data about a first aspect of an industrial process and determines whether the user is authorized to view data about a second aspect of the industrial process related to the first. An inactive informational display item is generated when the user is not authorized to view the data about the second aspect. The informational display item provides a visual indication of the relationship between the first and second aspects and is non-selectable for navigating to another display. An active navigational display item is generated when the user is authorized to view the data about the second aspect. The navigational display item provides a visual indication of the relationship between the first and second aspects and is selectable for navigating to a second view including data about the second aspect.

### CROSS-REFERENCE TO RELATED APPLICATION

This application is a continuation-in-part of U.S. patent application Ser. No. 14/194,151, filed Feb. 28, 2014, entitled LINE MANAGEMENT IN MANUFACTURING EXECUTION SYSTEM. The entire contents of the above application are hereby incorporated by reference.

### BACKGROUND

A manufacturing execution system (MES) monitors production and records various production/manufacturing events in an industrial process for use in managing the process. Based on the monitored and recorded information, an MES produces a series of views that report the performance of the industrial process to one or more users. Conventional industrial processes are arranged logically. Physical assets are arranged in an ordered sequence to perform process steps. Oftentimes, responsibility for the physical assets of an industrial process is divided among various personnel. Such personnel may only have a need to view performance information about the aspects of the industrial process for which they have responsibility. Accordingly, an MES that tailors the presentation of graphical content to suit the needs of its users is desired.

### SUMMARY

Briefly, aspects of the present invention generally relate to networked computerized systems utilized to monitor, log, and display relevant manufacturing/production events and associated data, such as a manufacturing execution system (MES). Such an MES generally executes above/outside of a control layer of a manufacturing/process control system to record production events and related event data. Aspects of the invention relate to improving the user experience of a user of an MES by tailoring the presentation of graphical content to suit a user's role in an industrial process. For instance, user credentials define user authorizations to view graphical content. Based on a user's credentials, the MES selectively displays MES content the user is authorized to view and hides MES content for which the user lacks credentials. In addition, the MES selectively displays navigational selection objects that navigate to MES content a user is authorized to view or functionality a user is authorized to utilize based on a user's credentials. By hiding graphical content and navigational selection objects that are not important to a user, the MES tailor's the views to suit a user's needs.

In one aspect, a manufacturing execution system configured to manage an industrial process comprises an authentication module configured to determine whether a user is authorized to view data about a first aspect of the industrial process and data about a second aspect of the industrial process that is directly related to the first aspect of the industrial process. A data collection module is operatively connected to the industrial process and configured to receive the data about the first and second aspects of the industrial process from the industrial process and to store the received data. A visualization module is operatively connected to the authentication system and the data collection system and configured to receive an indication from the authentication system that said user is authorized to view the data about the first aspect of the industrial process. The data about the first aspect of the industrial process is received from the data collection system. A first view including the data about the first aspect of the industrial process is displayed. An indication is received from the authentication system relating to whether said user is authorized to view the data about the second aspect of the industrial process from a group of indications consisting of a non-authorization indication indicating said user is not authorized to view the data about the second aspect of the industrial process and an authorization indication indicating said user is authorized to view the data about the second aspect of the industrial process. Responsive to the indication from said group of indications, the visualization module displays a display item selected from a group of display items consisting of an informational display item when the visualization system receives the non-authorization indication and a navigational display item when the visualization system receives the authorization indication. The informational display item provides a visual indication of the relationship between the first aspect of the industrial process and the second aspect of the industrial process and is non-selectable for navigating to another display. The navigational display item provides a visual indication of the relationship between the first aspect of the industrial process and the second aspect of the industrial process and is selectable for navigating to a second view including the data about the second aspect of the industrial process.

In another aspect, a processor-executable method of provides navigation between views in a manufacturing execution system configured to selectively report information about aspects of an industrial process to authorized users of the manufacturing execution system. Said method comprises displaying a first view including data about a first aspect of the industrial process to a user of the manufacturing execution system who is authorized to view the data about the first aspect of the industrial process. Said method also comprises determining whether said user is authorized to view data about a second aspect of the industrial process that is directly related to the first aspect of the industrial process. An inactive informational display item is generated when it is determined said user is not authorized to view the data about the second aspect of the industrial process and the informational display item is displayed in the first view. The informational display item provides a visual indication of the relationship between the first aspect of the industrial process and the second aspect of the industrial process and is non-selectable for navigating to another display. An active navigational display item is generated when it is determined said user is authorized to view the data about the second aspect of the industrial process and the navigational display item is displayed in the first view. The navigational display item provides a visual indication of the relationship between the first aspect of the industrial process and the second aspect of the industrial process and is selectable for navigating to a second view including the data about the second aspect of the industrial process.

In another aspect, a non-transitory computer-readable medium for navigating in a manufacturing execution system configured to selectively report information about aspects of an industrial process to authorized users of the manufacturing execution system comprises instructions stored thereon. When executed by a processor, the instructions perform the step of displaying a first view including data about a first aspect of the industrial process to a user of the manufacturing execution system who is authorized to view the data about the first aspect of the industrial process. The instructions also perform the step of determining whether said user is authorized to view data about a second aspect of the industrial process that is directly related to the first aspect of the industrial process. An inactive informational display item is generated when it is determined said user is not authorized to view the data about the second aspect of the industrial process and the informational display item is displayed in the first view. The informational display item provides a visual indication of the relationship between the first aspect of the industrial process and the second aspect of the industrial process and is non-selectable for navigating to another display. An active navigational display item is generated when it is determined said user is authorized to view the data about the second aspect of the industrial process and the navigational display item is displayed in the first view. The navigational display item provides a visual indication of the relationship between the first aspect of the industrial process and the second aspect of the industrial process and is selectable for navigating to a second view including the data about the second aspect of the industrial process.

Other objects and features will be in part apparent and in part pointed out hereinafter.

### BRIEF DESCRIPTION OF THE DRAWINGS

FIG. 1 is a schematic block diagram of an exemplary industrial process;

FIG. 2 is a schematic block diagram of an MES;

FIG. 3 is a schematic block diagram of a configuration database of the MES;

FIG. 4 is a screenshot of an entity model configuration view generated by the MES;

FIG. 5 is a screenshot of an entity detail view generated by the MES;

FIG. 5A is a screenshot of the entity detail view of FIG. 5 as presented to a user with different credentials;

FIG. 6 is a screenshot of a root menu view generated by the MES;

FIG. 6A is a screenshot of the root menu view with a drop down menu selected;

FIG. 7 is a screenshot of a line collection view generated by the MES;

FIG. 8 is a screenshot of an entity collection view generated by the MES;

FIG. 9 is a screenshot of a work order collection view generated by the MES;

FIG. 10 is a table illustrating a credentials database of the MES;

FIG. 11 is a flow chart illustrating the steps and decision blocks in a method of determining an initial view to be generated by the MES; and

FIG. 12 is a flow chart illustrating the steps and decision blocks in a method of determining whether to present an informational display item or a navigational display item in the entity detail view.

Corresponding reference characters indicate corresponding parts throughout the drawings.

### DETAILED DESCRIPTION

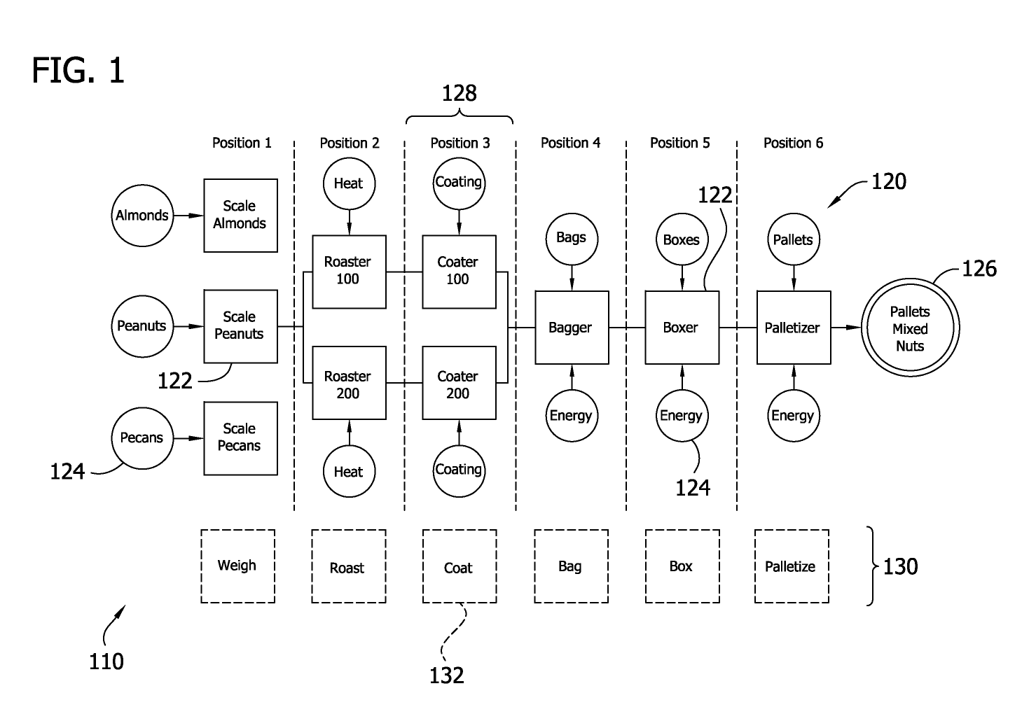

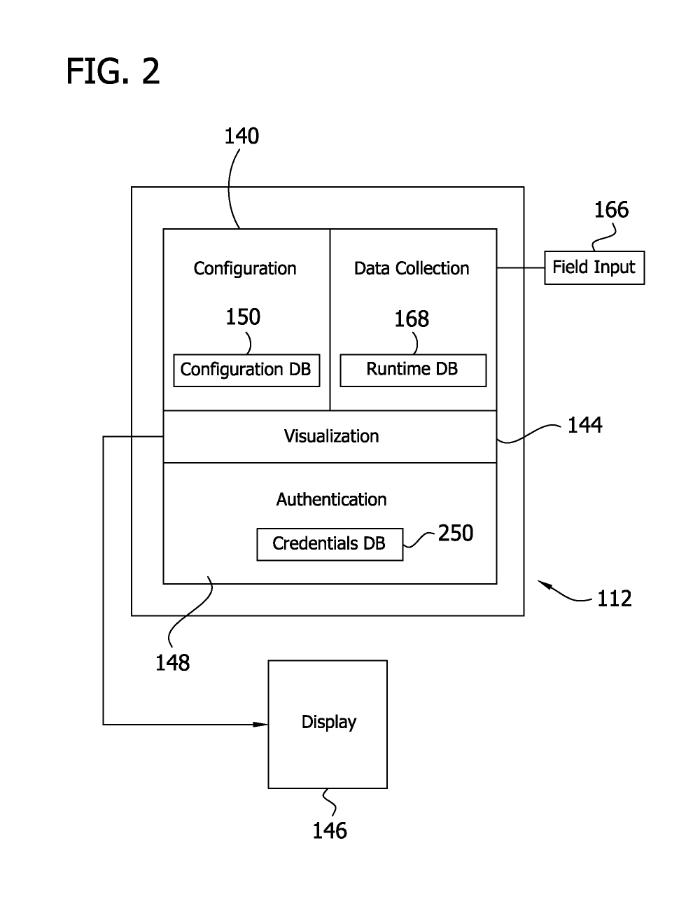

Referring to FIG. 1, an exemplary industrial process is generally indicated at reference number 110. The illustrated industrial process 110 is a food production facility that produces pallets of mixed nuts. As discussed in further detail below in reference to FIG. 2, an MES 112 monitors the performance of various aspects of the mixed nuts production facility 110 and provides reports on the production performance to a user. It will be understood that the mixed nut production facility 110 is merely one example of the many kinds of industrial processes that can be used with the MES 112. As will be appreciated, the MES 112 tailors the information reported to each user based on the user's role in an industrial process of any type and provides direct, intuitive navigation between views reporting production information about related aspects of the industrial process.

Referring to FIG. 1, certain aspects of the industrial process 110 that the MES 112 models and whose performance the MES tracks will now be discussed. It will be understood that, in other embodiments, the MES models and tracks the performance of other aspects of industrial processes without departing from the scope of the invention. For purposes of illustration, the industrial process 110 includes a single production line 120 comprising a plurality of entities 122. A “line” is a sequence of “entities” 122 that perform one or more tasks to transform one or more line inputs (e.g., line inputs 124) to one or more line outputs (e.g., line outputs 126). “Entities” are physical assets in an industrial process whose activity is tracked by the MES 112. In the illustrated industrial process, each of the entities 122 is a piece of equipment that performs discrete tasks. But in other embodiments, an “entity” can be an entire plant, an area of a plant (e.g., a production floor or warehouse), an organizational group of machines (e.g., those in a particular department), a piece of equipment (e.g., a mixer, dispenser, palletizer, etc.), or a component module of a piece of equipment. When an entity 122 is a component of a line 120, the entity is understood to be the child of the line and the line is understood to be a parent to the entity.

The terms “line” and “entity” refer to how an MES interacts with the physical assets they describe. Certain physical assets function as a line or an entity, depending on how the MES models them and tracks their performance. For example, in certain MES configurations, a line is a group of machines that, in the physical industrial process, perform an ordered sequence of tasks. Other configurations of the MES can treat the same group of machines as a single “entity” for purposes of tracking the performance of the industrial process. In such a configuration, the MES monitors and reports the production of the group of machines as a whole, rather than tracking the incremental production of each machine in the group separately. To the extent the MES monitors and reports the production of separate entities and also recognizes the logical arrangement of the separate entities in an ordered group, the group of entities is treated as a “line.”

In the illustrated industrial process 110, the production line 120 includes several entities 122 that operate in sequence to produce pallets of mixed nuts 126. Various line inputs 124 such as ingredients, energy, packaging, etc. are processed to produce the pallets of mixed nuts 126. The MES divides the entities 122 by line position 128. In certain configurations, the MES 112 groups two or more parallel entities 122, such as the scale entities in FIG. 1, in the same line position 128. In addition, the MES can structure a line 120 so that single entities 122 are arranged in sequence, with each entity occupying its own line position 128. The entities 122 at each line position 128 receive entity inputs and produce entity outputs (e.g., the boxer entity produces boxes of mixed nuts as an entity output) to advance the production of the line outputs 126. Entity inputs include line inputs 124 or the entity outputs from an entity in the immediately prior line position 128.

To produce line outputs 126 from line inputs 124, the line 110 processes a work order 130. The work order 130 is a sequence of one or more jobs 132 that entities 122 perform to produce line outputs 126 from line inputs 124. A work order 130 can run on any line 120 that has entities 122 capable of carrying out its jobs 132. At runtime, a work order 130 is assigned to a line 120, and one or more entities 122 on the line perform the jobs 132, thereby carrying out the work order. The MES 112 preferably tracks the progress and status of each work order 130 and job 132 in real time or near real time.

Referring to FIG. 2, the illustrated MES 112 includes tools for modeling various aspects of the industrial process 110, as well as tracking and reporting the performance of the industrial process in operation. The MES 112 includes a configuration module 140 for configuring and storing models of various aspects of the industrial process 110, a data collection module 142 for receiving and storing data about the performance of the industrial process, and a visualization module 144 for presenting graphical displays including configuration views and production performance views on a display 146. The visualization module 144 is operably connected to the configuration module 140 and data collection module 142 so that an MES user can interact with the configuration and data collection modules through the display 146. An authentication system 148 authenticates the identities of users of the MES 112 and manages each user's access to MES content and capabilities. As will be discussed in further detail below, the authentication system 148 is operably connected to the visualization module 144 to tailor the display of MES views to suit a user's role in the industrial process 110.

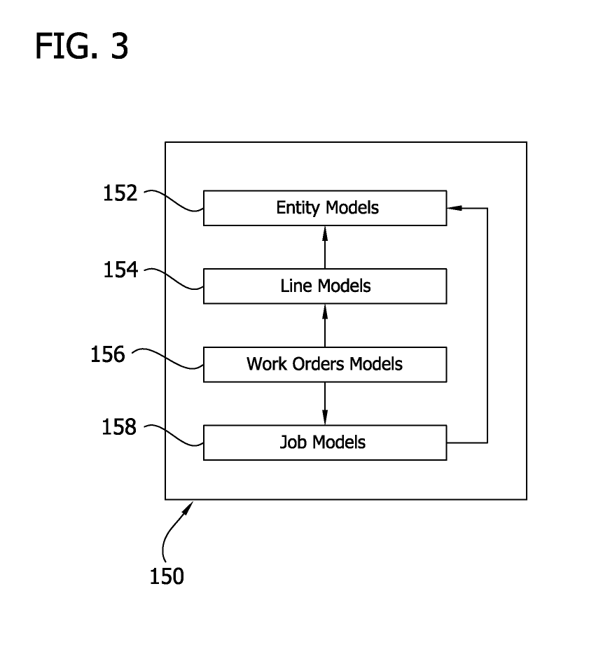

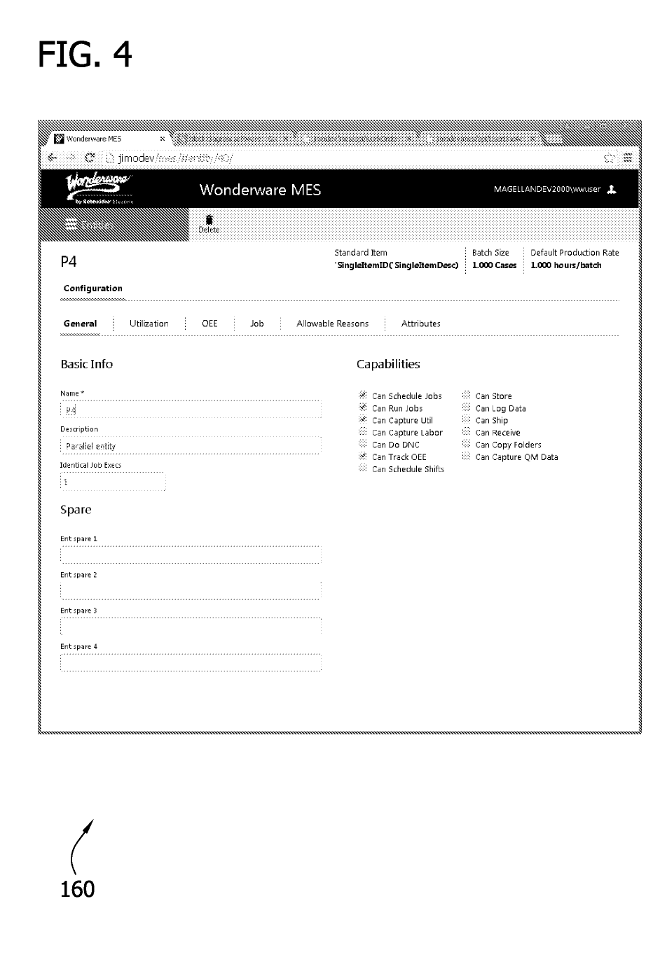

The configuration module 140 is configured to model aspects of the industrial process 110 and to store the models in a configuration database 150. As shown in FIG. 3, the illustrated configuration database 150 stores one or more entity models 152, line models 154, work order models 156, job models 158, and the like. In other embodiments, the configuration database 150 stores models of other aspects of the industrial process 110 without departing from the scope of the invention. In one or more embodiments, each of the models 152, 154, 156, 158 stores various user-defined parameters about the aspect of the industrial process 110 it represents. The visualization module 144 uses these parameters along with data collected by the data collection module 142 to generate views containing data representative of the performance of the lines 120, entities 122, and work orders 130 at runtime. The visualization module 144 is also configured to generate configuration views for each of the different types of models 152, 154, 156, 158 and to display the configuration views on the display 146. For example, FIG. 4 illustrates a suitable configuration view 160 for an entity model 152. An MES user interacts with the configuration view 160 to create the entity model 152 and to edit the entity model after it has been created.

Preferably, the configuration database 150 stores relationships between the models 152, 154, 156, 158 that reflect the actual relationships between the physical assets in the industrial process 110. For example, for an entity 122 that is a child of a line 120, the configuration database 150 stores an indication of a parent-child relationship between the respective entity model 152 and line model 154. In one embodiment, the configuration database 150 is an SQL database and each model 152, 154, 156, 158 comprises one or more SQL records having a primary key identifier. The configuration database 150 could, in such an embodiment, use foreign key identifiers to track the relationships between the various models 152, 154, 156, 158. For example, in one or more embodiments, the records of a line model 154 include foreign key identifiers referencing the primary key identifiers of the related (i.e., child) entity models 152. Likewise, in certain embodiments, the records of a work order model 156 include foreign key identifiers referencing the primary key identifiers of the constituent (i.e., child) job models 158. When a work order 130 is assigned to a line 120, the configuration database suitably stores a foreign key identifier for the respective line model 154 in the respective work order model 156. Preferably, the visualization module 144 presents configuration views on the display 146 from which the user models and observes the relationships between related aspects of the industrial process.

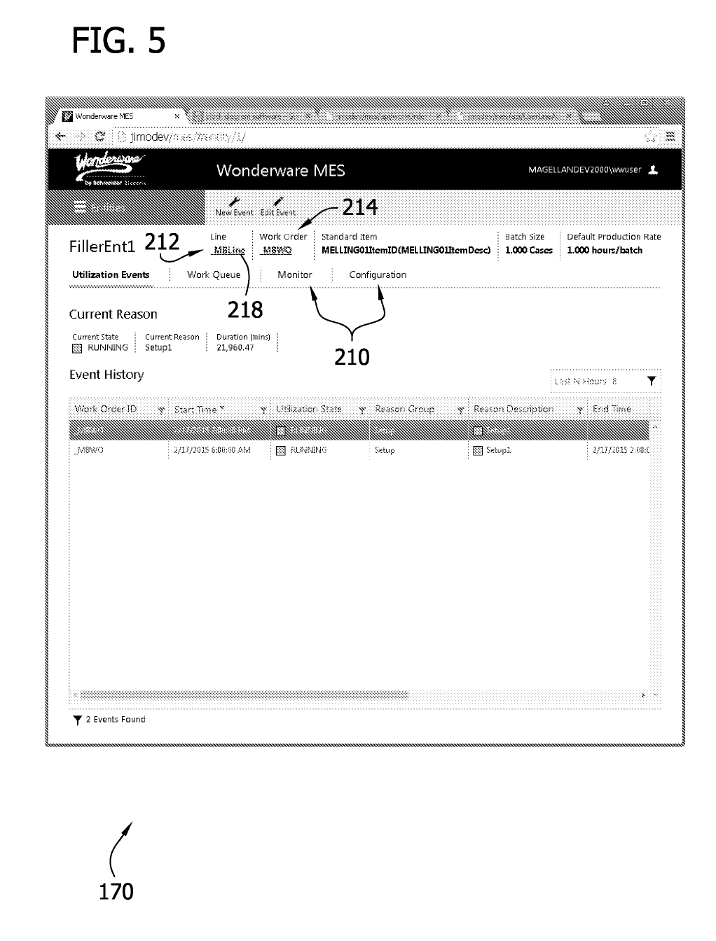

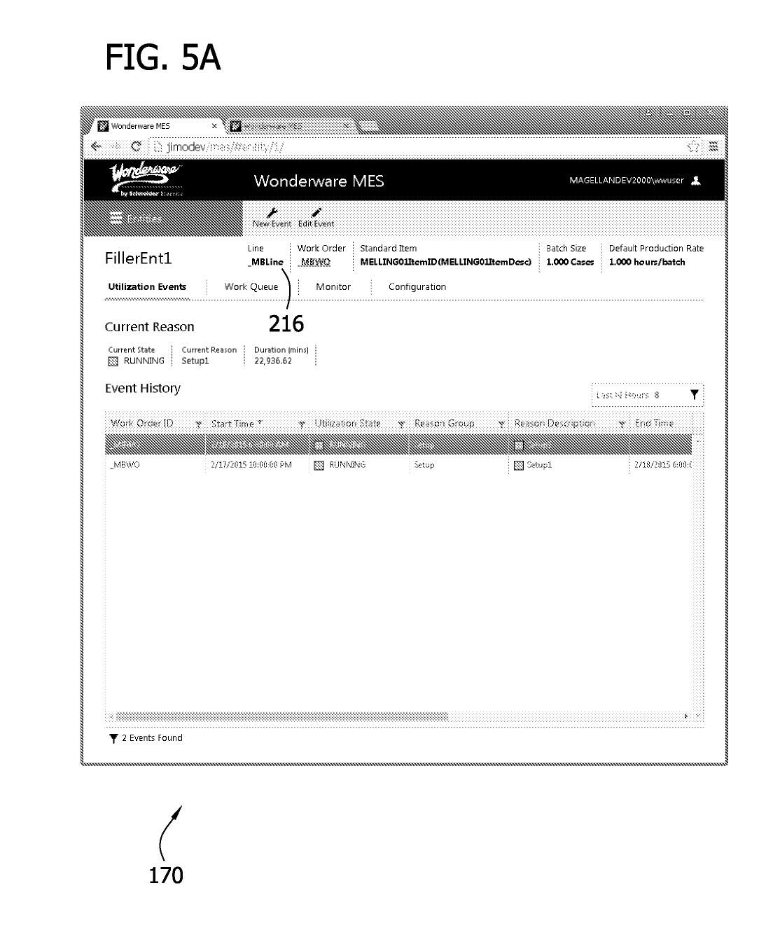

Referring again to FIG. 2, the data collection module 142 is operably connected to the industrial process 110 to receive and store data about the performance of the industrial process. Field inputs 166 provide real time or near real time data from the floor of the industrial process 110 to the data collection module 142, and the data collection module stores the data in a runtime database 168. The field inputs 166 are provided by one or more sensors associated with the entities 122 and/or input by human operators. In general, the field inputs 166 provide data about the performance of the entities 122 as they perform their jobs 132. For example, in certain exemplary embodiments, the field inputs provide production count data, which measures the amount of entity outputs (e.g., good units and rejected units) being produced by the entity, and availability data, which measures the amount of time an entity spends in a ready or running operational state versus the amount of time an entity is unavailable. The data collection module 142 organizes the collected data in the runtime database 168, and the visualization module 144 displays views that contain the data on the display 146. For example, FIG. 5 illustrates a suitable detail view 170 with runtime data for an entity 122. Preferably, the visualization module 144 also displays other kinds of detail views for other aspects of the industrial process 110.

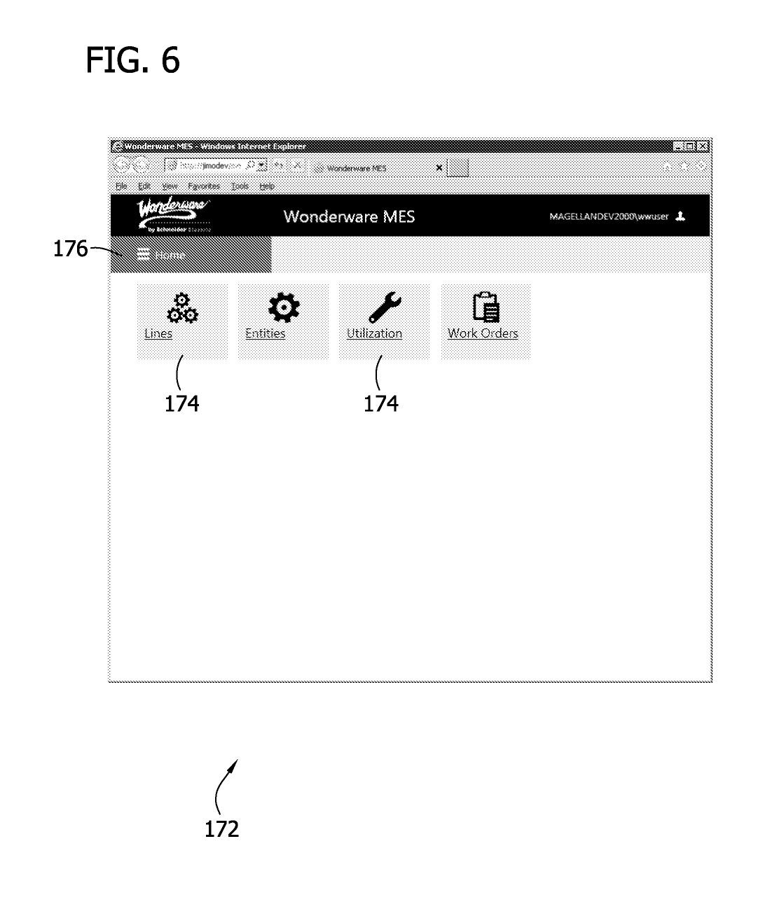

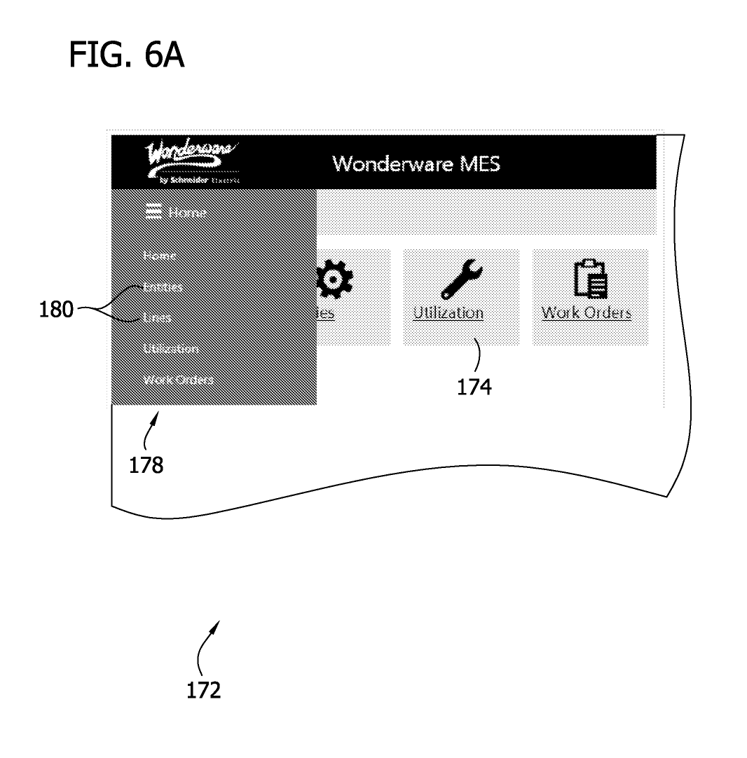

In the illustrated embodiment, the visualization module 144 is configured to display several different views to enable MES users to interact with the configuration and data collection modules 140, 142. Typically, when a user first accesses the MES 112, the visualization module 144 presents a root menu view 172, which is illustrated in FIG. 6. It will be understood that the illustrated root menu view 172 is one suitable example of the format and content of a root menu view. In other embodiments, the root menu views are formatted differently and/or present different content without departing from the scope of the invention. As will be discussed in further detail below, the authentication system 148 controls whether the visualization module 144 initially generates a root menu view 172 or some other view based on the MES content the user is authorized to view. In addition, the authentication system 148 controls the graphical content presented in the home view 172 based on the MES content the user is authorized to view. In FIG. 6, the home view 172 includes selection objects 174 for lines, entities, utilization, and work orders. By selecting the selection objections 174, the user navigates to a respective collection view. The collection views for lines, entities, and work orders are discussed in further detail below. The home view 172 also includes a drop down menu selection object 176.

As shown in FIG. 6A, when a user selects the drop down menu selection object 176, a drop down menu 178 appears with additional selection objects 180 that enable navigation to the collection views for lines, entities, utilization, and work orders.

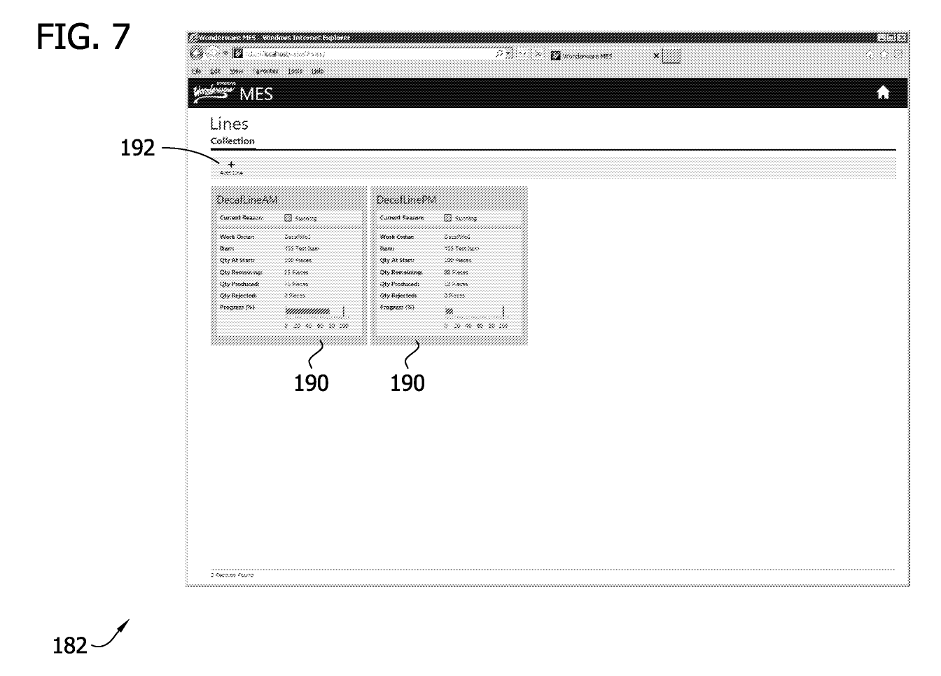

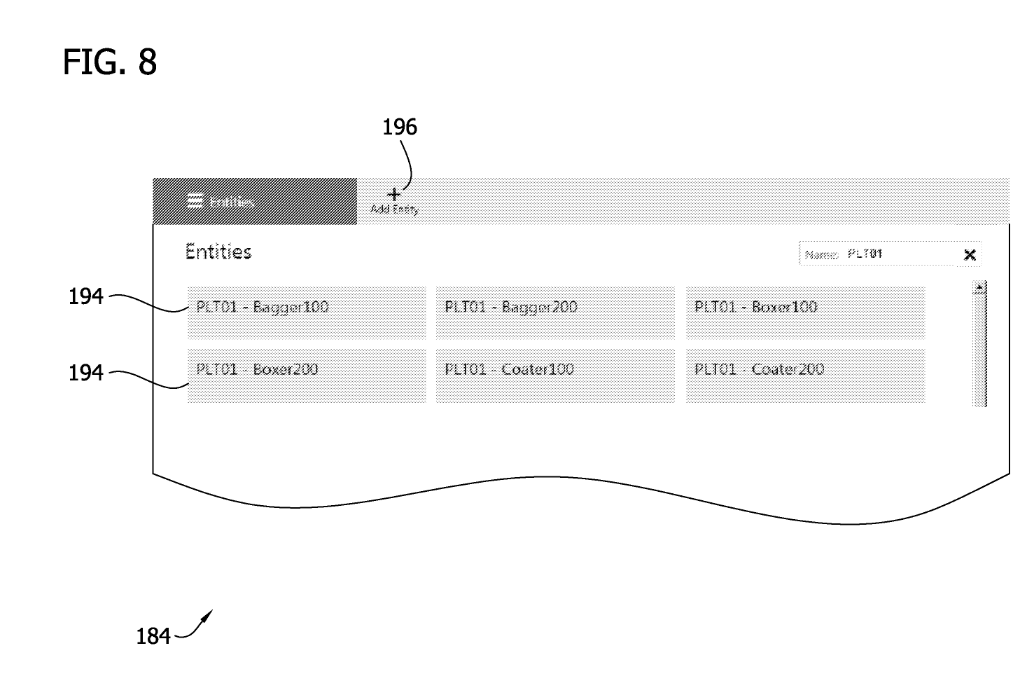

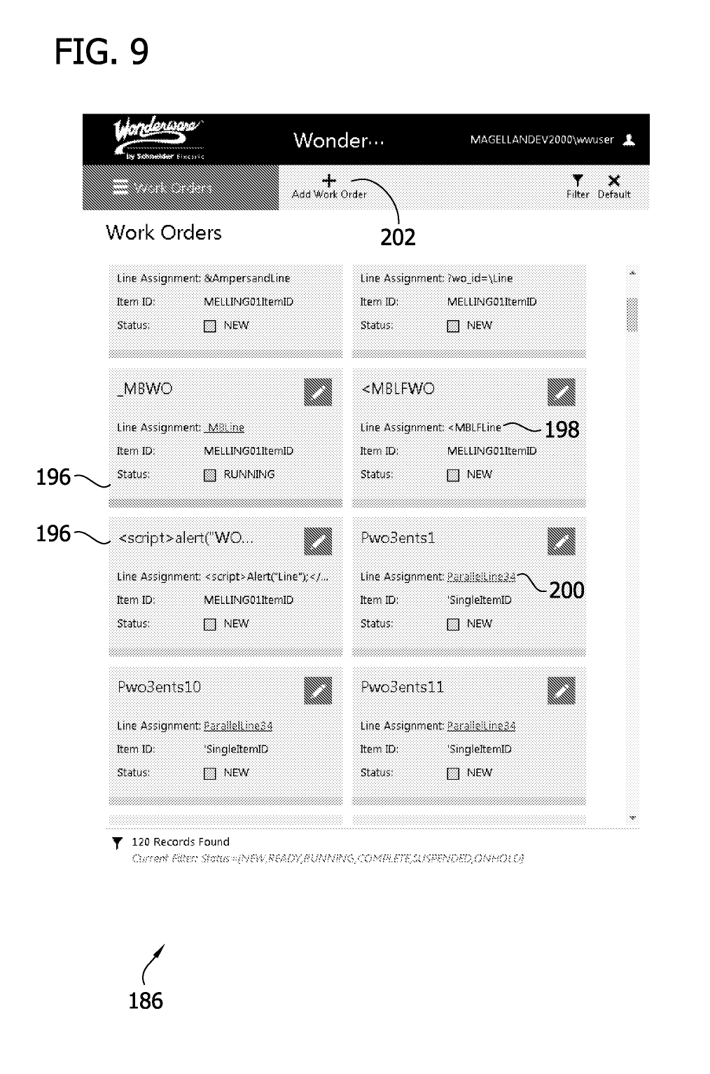

As shown in FIGS. 7-9, when a user selects the selection objects 174 from the home view 172, the visualization module 144 directs the user to a respective collection view 182, 184, 186 for lines 120, entities 122, or work orders 130. Referring specifically to FIG. 7, the line collection view 182 includes summary objects 190 for each of the lines 120 that are modeled in the configuration database 150. The summary objects 190 present an overview of the data stored in the runtime database 168 for the respective line 120. When a user selects one of the summary objects 190, the visualization module 144 navigates to a detail view for the respective line 120 (not shown), which displays runtime information about the line 120 and configuration tools for editing the line model 154 as the authentication system 148 allows. In addition, an authorized user selects a new line selection objection 192 to create a new line model 154. Referring specifically to FIG. 8, the entity collection view 184 includes objects 194 for each of the entities 122 modeled in the configuration database 150. When a user selects one of the objects 194, the visualization module navigates to a detail view 170 for the respective entity 122, which displays runtime information about the entity 122 and configuration tools for editing the entity model 152 as the authentication system 148 allows. A new entity selection object 196 can be selected to create a new entity model 152. As shown in FIG. 9, the work order collection view 186 includes a summary object 196 for each of the work order models 156 in the configuration database. Each summary object 196 presents an overview of the performance data stored in the runtime database 168 for the respective work order 130.

As will be discussed in further detail below, depending on a user's authorization, the visualization module 144 can present an informational display item 198 or a navigational display item 200 that indicates the line 120 to which the respective work order 130 is assigned. The work order collection view 186 also includes a new work order selection objection 202 for adding a new work order model 156 to the configuration database 150. It will be understood that the illustrated collection views 182, 184, 186 are suitable examples of the format and content of such views. In other embodiments, the collection views are formatted differently and/or present different content without departing from the scope of the invention.

Referring again to FIG. 5, when a user selects an entity object 194 from the entity collection view 184, the user is directed to an entity detail view 170. The entity detail view 170 includes a set of tabs 210 for navigating to portions of the detail view that display different information about the performance and configuration of the entity 122 and enable the user to perform different MES operations. For example, when a user selects the “Configuration” tab, the visualization module 144 navigates to the entity model configuration view 160 illustrated in FIG. 4, from which the user views configuration information for the entity model 152 and edits the model. After an entity model 152 has been stored in the configuration database 150, the visualization module 144 groups the configuration view 160 for the entity models 152 with the other tabs of the entity detail view 170. As will be discussed in further detail below, the visualization module 144 selectively omits certain ones of the tabs 210 from the entity detail view 170 when an MES user does not have authorization to access the content available at those tabs. The entity detail view 170 includes a line field 212 and a work order field 214, which provide respective indications of the line 120 to which the entity 122 is assigned and the work order 130 that is presently assigned to the line. As will be discussed in further detail below, depending on whether the MES user is authorized to access the respective line and work order models 154, 156, the visualization module 144 will present either a plain text informational item 216 (FIG. 5A) or a hyperlink navigational item 218 (FIG. 5) in the fields 212, 214. It will be understood that the illustrated entity detail view 170 is but one suitable example of the format and content of such a view. In other embodiments, the entity detail view is formatted differently and/or presents different content without departing from the scope of the invention.

Though not illustrated separately, it will be appreciated that the visualization module 144 also generates detail views for other aspects of the industrial process 110. Moreover, in one or more embodiments, the detail views for the other aspects of the industrial process 110 include tabs for navigating to portions of the detail views from which a user can view different information about the performance and configuration of the respective aspects of the industrial process and perform different MES operations. Likewise, in certain embodiments, the detail views of other aspects of the industrial process 110 include fields for displaying one of an informational and a navigational item for one or more related entities.

The authentication system 148 manages user access to the various views that the visualization module 144 generates on the display 146. As shown in FIG. 2, the authentication system 148 includes a credentials database 250. The credentials database 250 stores user names 252 and passwords 254 for each of the MES users, as well as profiles 256 that define authorizations for each user. The authentication system 148 is configured to verify the identity of an MES user to associate the user with a user profile 256. When a user attempts to access the MES 112 from the display 146, the visualization module 144 presents a login view (not shown), where the user is prompted for his or her user name 252 and password 254. Once the user has entered a valid user name and password combination the authentication system 148 queries the user's profile 256 to determine the content the user is authorized to access and the MES operations the user is authorized to perform.

The illustrated user profiles 256 include one or both of two types of credentials: privilege credentials 260 and access credentials 262. In one embodiment, users are assigned to user groups based on the role the user performs in the industrial process 110. Each member of a user group has the same privilege and access credentials 260, 262, which suitably authorize the users to view the MES content required to do their jobs. In other embodiments, user credentials are managed on an individual basis, rather than as a group. Privilege credentials 260 authorize a user to perform operations in the MES 112. Access credentials 262 authorize the user to access data about one or more aspects of the industrial process 110. In the illustrated embodiment, the authentication system 148 is configured to recognize and enforce many types of privilege credentials 260 and access credentials 262. For example, the authentication system 148 enforces privilege credentials 260 for operations such as configuring and editing the models 152, 154, 156, 158, assigning work orders 130 to lines 120, etc. A user can be granted the privilege with respect to all aspects of the industrial process 110 of a certain type (e.g., “Manager” has a privilege credential authorizing the user to create and edit all line models 154, entity models 152, work order models 156, and job models 158), or the user can be granted the privilege with respect to particular ones of the entities (e.g., “Entity Technician” has a privilege credential to edit an entity model 154 for entity A). The illustrated authentication system 148 is configured to recognize and enforce many types of access credentials 262. For example, the authentication system 148 includes access credentials 262 for accessing the views produced by the visualization module 144 regarding the performance of all lines 120, individual lines, all entities 122, and individual entities. In other embodiments, an MES recognizes and enforces other types of access credentials without departing from the scope of the invention.

Several methods of tailoring the graphical content of the MES 112 to suit the role(s) of a particular user will now be discussed. In the following discussion, the methods are described in reference to the views illustrated in FIGS. 5-10. It will, however, be understood that the methods may also be adapted to be used with other views without departing from the scope of the invention. Although the methods are discussed in reference to views containing information about specific aspects of the industrial process 110, in other embodiment the methods are adapted for use with views of other aspects of an industrial process without departing from the scope of the invention.

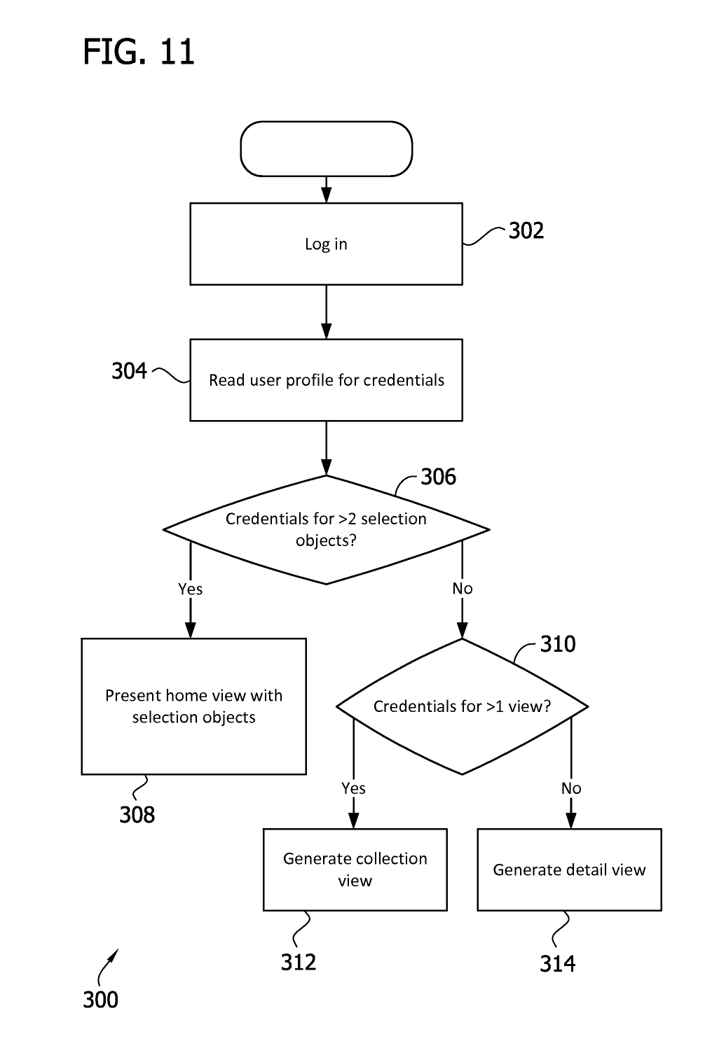

Referring to FIG. 11, in one embodiment, after a user has logged into the MES 112, the MES performs a method of determining an initial view to present to a user 300. As will be apparent, the method 300 directs the user to a view that contains selection objects for navigating to other MES views for which the user has privilege or access credentials 260, 262 (if any) and that hides selection objects for navigating to MES views for which the user lacks credentials. At step 302 the user logs into the MES 112. When the authentication system 148 receives a valid user name 252 and password 254 from the user, the authentication system associates the user with a user profile 186. At step 304, the authentication system 148 reads the privilege and access credentials 260, 262 for the user. At decision block 306, the authentication system 148 determines whether the user has privilege and access credentials 260, 262 for views that two or more of the selection objects 174 of the root menu view 172 navigate to when selected.

To determine whether two or more of the root menu selection objects 174 should be displayed, the authentication system 148 preferably provides the visualization module 144 with a suitable indication of the user's privilege and access credentials 260, 262. If the user has privilege or access credentials 260, 262 for at least one view for a line 120, entity 122, or work order 130, the respective root menu selection object 174 can be used to navigate to the view(s). Thus, if the authentication system 148 provides the visualization module 144 with an indication that the user has privilege or access credentials for views for a line 120, entity 122, or work order 130, the visualization module determines that the root menu selection object 174 for the respective aspect of the process should be displayed. If the visualization module 144 determines that two or more of the root menu selection objects 174 should be displayed, at step 308, the visualization module 144 presents a home view 172 with selection objects 174 that navigate to views for which the user has privilege or access credentials 260, 262. Thus, if the user has privilege or access credentials 260, 262 for views for lines 120, entities 122, and work orders 130, the visualization module generates a home view 172 with three selection objects. For example, if the user only has credentials for views for lines 120 and work orders 130, the visualization module 144 generates a home view 172 with two selection objects. The visualization module hides the selection object 174 that navigates to views for which the user lacks credentials.

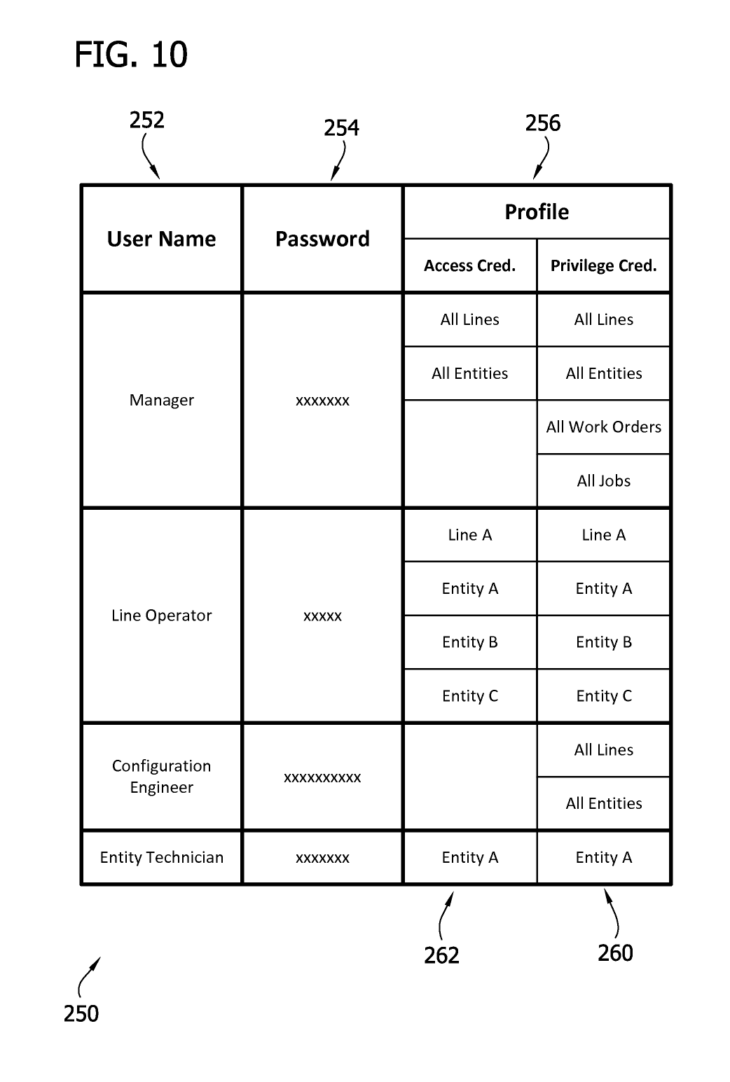

If visualization module 144 receives an indication that the user only has credentials for one or more views that can be reached through one of the root menu selection objects 174 (i.e., the user only has credentials for one or more entities 122, and not for lines 120, utilization, or work orders 130), at decision block 310, the authentication system 148 determines whether the user has privilege or access credentials for more than one view. For example, if the user only has privilege or access credentials for entities 122, the authentication system 148 determines whether the user has credentials for a single entity or for more than one entity. If the user has credentials for more than one view (e.g., more than one entity 122), at step 312 the visualization module 144 generates a collection view displaying selection or summary objects for each of the aspects of the industrial process 110 for which the user has privilege or access credentials 260, 262 while hiding selection and summary objects for each of the aspects of the industrial process for which the user lacks privilege or access credentials. For example, if a user only has privilege or access credentials for two lines 120, “DecafLineAM” and “DecafLinePM,” as shown in FIG. 7, the visualization module 144 generates a line collection view 182 with one summary object 190 for each of the lines and hides summary objects for all other lines. When the MES user has privilege or access credentials 260, 262 to only a single aspect of the industrial process 110, rather than multiple aspects of the same type, at step 314, the visualization module 144 generates a detail view (e.g., the entity detail view 170 of FIG. 5) for the respective aspect. For example, if like the “Entity Technician” in FIG. 10, the user only has access to a single entity 122, then the MES 112 displays the entity detail view 170 for the respective entity after login.

When an authorized user accesses an entity detail view 170, the MES 112 hides selection items that navigate to content for which the user lacks credentials 260, 262. Although the following discussion makes reference to selectively displaying navigation objects in the entity detail view 170, it will be understood that the MES 112 may selectively display and hide navigational links in other types of views without departing from the scope of the invention. As discussed above, the entity detail view 170 includes tabs 210 for navigating between portions of the detail view that display different MES content and enable a user to perform different MES operations. In certain instances, a user profile 256 includes access credentials 262 for an entity 122, but not privilege credentials 260. Likewise, in some instances, a user profile includes privilege credentials 260 and lacks access credentials 262. Before the visualization module 144 generates an entity detail view 170, the authentication system 148 reads the user profile for the logged-in user to determine what credentials the user has for the respective entity 122 and provides an indication of the credentials to the visualization module 144. If the user has access credentials 262 and privilege credentials 260, the visualization module 144 generates an entity detail view 170 like the one illustrated in FIG. 5, which includes “Utilization Events,” “Work Queue,” and “Monitor” tabs, which permit the user to access runtime information about the respective entity 122, as well as a “Configuration tab,” which permits the user to edit the respective entity model 152. If the user only has access credentials 262 for the entity 122, the visualization module hides the “Configuration” tab 210. And if the user only has privilege credentials 260, the visualization module 144 hides the “Utilization Events,” “Work Queue”, and “Monitor” tabs for the entity 122. In this case, the visualization module 144 generates an entity model configuration view 160, like the one illustrated in FIG. 4.

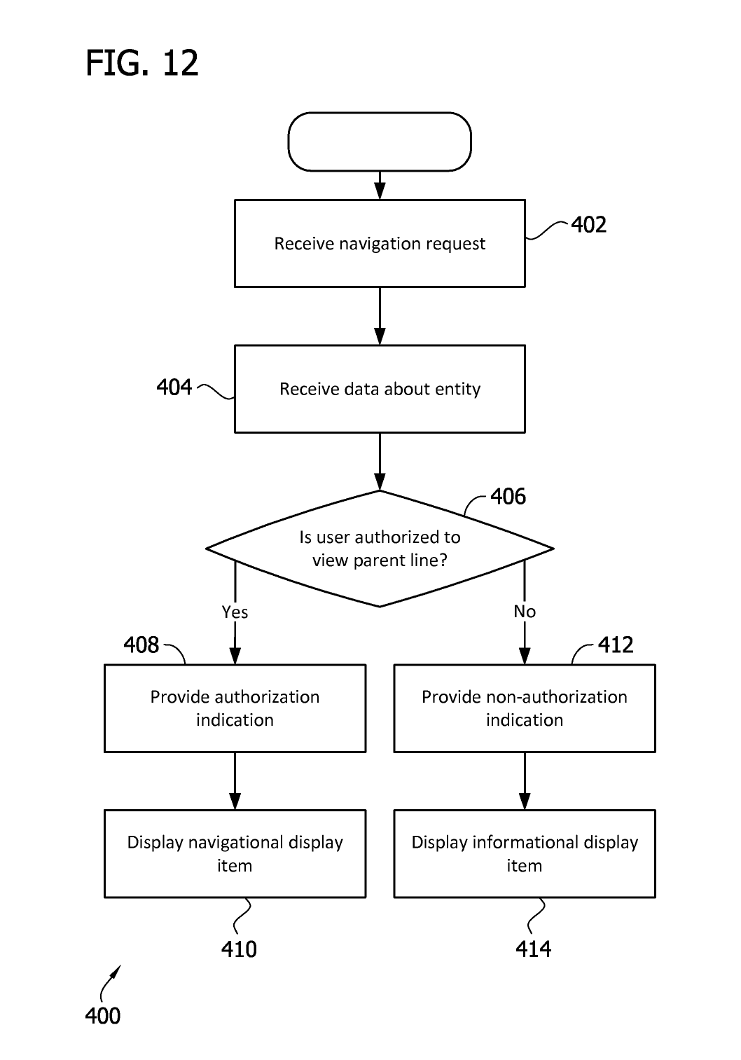

Referring to FIGS. 5 and 5A in connection with FIG. 12, in one or more embodiments, the MES 112 is configured to determine whether to provide an informational display item 216 or a navigational display item 218 to populate the line field 212 of the entity detail view 170 using the method 400. It will be understood that a method 400 can be adapted for use with other detail views that include fields for displaying an indication of a related aspect of an industrial process without departing from the scope of the invention. In a first step 402, the MES 112 receives a request from the user to navigate to the entity detail view 170 for an entity 120. To make such a request, the user will typically have access to a selection object (e.g., a selection object 194 of FIG. 8) for navigating to the entity detail view 170 from another view (e.g., the entity model collection view 184). Prior to receiving the request to navigate to the entity detail view 170, the visualization module 144 receives an indication from the authentication system 148 that user has privilege credential 260 or access credential 262 for the entity 122 and displays the navigational selection object (e.g., the selection object 194 of FIG. 8) for navigating to the entity detail view 170.

After receiving the request to navigate to the entity detail view 170, the visualization module receives data about the entity 122 from the data collection module 142 (step 404). At decision block 406, the authentication system 148 determines whether the user is authorized to navigate to a view for the line 120 that is the parent to the entity 122 (broadly, whether the user is authorized to view data about the parent line, e.g., whether the user has access or privilege credentials for the respective line). If the user is authorized to navigate to the view for the parent line 122, at step 408, the authentication system 148 provides an authorization indication to the visualization module 144. And at step 410, the visualization module 144 displays a navigational display item 218 (FIG. 5) (e.g., a hyperlink that, when selected, navigates to the line detail view for the line 120) in the line field 212. If the user is not authorized to navigate to a view for the parent line 122, authentication system 148 provides a non-authorization indication to the visualization module 144 at step 412. At step 414, the visualization module displays a non-selectable informational display item 216 (FIG. 5A) (e.g., a plain text display item) that provides a visual indication of the relationship between the entity 122 and line 120, but does not permit navigation to the line detail view for the line.

As shown, in FIG. 9, the MES 112 is also configured to perform a similar method when generating a work order collection view 186. When a user requests the MES 112 to navigate to the work order collection view 186, the authentication system 148 determines whether the user is authorized to navigate to the view for the line 120 associated with each work order 130. For each work order 130, if the user has a privilege credential 260 or access credential 262 for the line 120 to which it is assigned, the authentication system 148 provides an authorization indication to the visualization module 144 and, in response to the indication, the visualization module generates a navigational display item 200 for the line in the respective work order summary object 196. If the user does not have an access credential 262 or privilege credential 260 for the line 120 to which the work order 130 is assigned, the authentication system 148 provides a non-authorization indication to the visualization module 144 and, in response to the indication, the visualization module generates an informational display item 198 for the line in the respective work order summary object 196.

As can be seen, the illustrated MES 112 uses credentials stored in a credentials database 250 to identify the MES content that the user is authorized to view. The visualization module 144 renders graphical views that include navigational selection objects for navigating to graphical content the user is permitted to view, while hiding navigational selection objects to graphical content the user is not permitted to view. Thus, the MES 112 tailors graphical views to suit its users' roles and streamlines the presentation of MES content to improve the user experience.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

For purposes of illustration, programs and other executable program components, such as the operating system, are illustrated herein as discrete blocks. It is recognized, however, that such programs and components reside at various times in different storage components of a computing device, and are executed by a data processor(s) of the device.

Although described in connection with an exemplary computing system environment, embodiments of the aspects of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one component or combination of components illustrated in the exemplary operating environment. Examples of well-known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the invention may be described in the general context of data and/or processor-executable instructions, such as program modules, stored on one or more tangible, non-transitory storage media and executed by one or more processors or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments of the aspects of the invention may be implemented with processor-executable instructions. The processor-executable instructions may be organized into one or more processor-executable components or modules on a tangible processor readable storage medium. Aspects of the invention may be implemented with any number and organization of such components or modules. For example, aspects of the invention are not limited to the specific processor-executable instructions or the specific components or modules illustrated in the figures and described herein. Other embodiments of the aspects of the invention may include different processor-executable instructions or components having more or less functionality than illustrated and described herein.

The order of execution or performance of the operations in embodiments of the aspects of the invention illustrated and described herein is not essential, unless otherwise specified. That is, the operations may be performed in any order, unless otherwise specified, and embodiments of the aspects of the invention may include additional or fewer operations than those disclosed herein. For example, it is contemplated that executing or performing a particular operation before, contemporaneously with, or after another operation is within the scope of aspects of the invention.

Throughout the specification and claims, terms such as “item,” “element,” “object,” etc. may be used interchangeably to generically describe or identify software or display features unless otherwise indicated.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the aspects of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the aspects of the invention by way of example and not by way of limitation. This description enables one skilled in the art to make and use the aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in their application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. It is contemplated that various changes could be made in the above constructions, products, and methods without departing from the scope of aspects of the invention. In the preceding specification, various preferred embodiments have been described with reference to the accompanying drawings. It will, however, be evident that various modifications and changes may be made thereto, and additional embodiments may be implemented, without departing from the broader scope of the aspects of the invention as set forth in the claims that follow. The specification and drawings are accordingly to be regarded in an illustrative rather than restrictive sense.

What is claimed is:

1. A manufacturing execution system configured to manage an industrial process comprising:
an authentication module configured to determine whether a user is authorized to view data about a first aspect of the industrial process and data about a second aspect of the industrial process that is directly related to the first aspect of the industrial process;
a data collection module operatively connected to the industrial process and configured to receive the data about the first and second aspects of the industrial process from the industrial process and to store the received data;
a visualization module operatively connected to the authentication system and the data collection system and configured to:
receive an indication from the authentication system that said user is authorized to view the data about the first aspect of the industrial process;
receive the data about the first aspect of the industrial process from the data collection system;
display a first view including the data about the first aspect of the industrial process;
receive an indication from the authentication system relating to whether said user is authorized to view the data about the second aspect of the industrial process from a group of indications consisting of:
a non-authorization indication indicating said user is not authorized to view the data about the second aspect of the industrial process; and
an authorization indication indicating said user is authorized to view the data about the second aspect of the industrial process; and
display, responsive to the indication from said group of indications, a display item selected from a group of display items consisting of:
an informational display item when the visualization system receives the non-authorization indication, the informational display item providing a visual indication of the relationship between the first aspect of the industrial process and the second aspect of the industrial process and being non-selectable for navigating to another display; and
a navigational display item when the visualization system receives the authorization indication, the navigational display item providing a visual indication of the relationship between the first aspect of the industrial process and the second aspect of the industrial process and being selectable for navigating to a second view including the data about the second aspect of the industrial process.

2. A manufacturing execution system as set forth in claim 1 wherein the first aspect of the industrial process is a child of the second aspect of the industrial process.

3. A manufacturing execution system as set forth in claim 1 wherein the data about the first aspect of the industrial process comprises real-time operational data.

4. A manufacturing execution system as set forth in claim 1 wherein the first aspect of the industrial process is an entity in the industrial process and the second aspect of the industrial process is a line in the industrial process to which the entity belongs.

5. A manufacturing execution system as set forth in claim 1 wherein the first aspect of the industrial process is a work order assigned to a line in the industrial process and the second aspect of the industrial process is the line to which the work order is assigned.

6. A manufacturing execution system as set forth in claim 1 wherein the informational display item is plain text.

7. A manufacturing execution system as set forth in claim 1 wherein the navigational display item is a hyperlink.

8. A manufacturing execution system as set forth in claim 1 wherein the authentication system is further configured to:
verify an identity of said user to associate said user with a user profile; and
query said user profile to determine whether said user is authorized to view the data about the first and second aspects of the industrial process.

9. A manufacturing execution system as set forth in claim 8 wherein said user profile comprises privilege credentials authorizing said user to perform operations in the manufacturing execution system with respect to one or more aspects of the industrial process and access credentials authorizing said user to access information about one or more aspects of the industrial process.

10. A manufacturing execution system as set forth in claim 9 wherein the authentication system is configured to query said user profile to determine whether said user profile includes at least one of a privilege credential and an access credential for the second aspect of the industrial process and wherein the authentication system is configured to provide the authorization indication to the visualization system when said user profile includes said at least one of the privilege credential and the access credential.

11. A processor-executable method of providing navigation between views in a manufacturing execution system configured to selectively report information about aspects of an industrial process to authorized users of the manufacturing execution system, said method comprising:
displaying a first view including data about a first aspect of the industrial process to a user of the manufacturing execution system who is authorized to view the data about the first aspect of the industrial process;
determining whether said user is authorized to view data about a second aspect of the industrial process that is directly related to the first aspect of the industrial process;
generating an inactive informational display item when it is determined said user is not authorized to view the data about the second aspect of the industrial process and displaying the informational display item in the first view, the informational display item providing a visual indication of the relationship between the first aspect of the industrial process and the second aspect of the industrial process and being non-selectable for navigating to another display; and
generating an active navigational display item when it is determined said user is authorized to view the data about the second aspect of the industrial process and displaying the navigational display item in the first view, the navigational display item providing a visual indication of the relationship between the first aspect of the industrial process and the second aspect of the industrial process and being selectable for navigating to a second view including the data about the second aspect of the industrial process.

12. A method as set forth in claim 11 wherein the first aspect of the industrial process is a child of the second aspect of the industrial process.

13. A method as set forth in claim 11 wherein the data about the first aspect of the industrial process comprises at least one of operational data and configuration data.

14. A method as set forth in claim 11 wherein the first aspect of the industrial process is an entity in the industrial process and the second aspect of the industrial process is a line in the industrial process to which the entity belongs.

15. A method as set forth in claim 11 wherein the first aspect of the industrial process is a work order assigned to a line in the industrial process and the second aspect of the industrial process is the line to which the work order is assigned.

16. A method as set forth in claim 11 wherein the informational display item is plain text.

17. A method as set forth in claim 11 wherein the navigational display item is a hyperlink.

18. A method as set forth in claim 11 further comprising:
verifying an identity of said user to associate said user with a user profile; and
querying said user profile to determine whether said user is authorized to view the data about the second aspect of the industrial process.

19. A method as set forth in claim 18 wherein said user profile comprises privilege credentials authorizing said user to perform operations in the manufacturing execution system with respect to one or more aspects of the industrial process and access credentials authorizing said user to access information about one or more aspects of the industrial process.

20. A method as set forth in claim 19 wherein said querying comprises querying said user profile for at least one of a privilege credential and an access credential for the second aspect of the industrial process to determine whether said user is authorized to view the data about the second aspect of the industrial process.

21. A non-transitory computer-readable medium for navigating in a manufacturing execution system configured to selectively report information about aspects of an industrial process to authorized users of the manufacturing execution system comprising instructions stored thereon that, when executed by a processor, perform the steps of:
displaying a first view including data about a first aspect of the industrial process to a user of the manufacturing execution system who is authorized to view the data about the first aspect of the industrial process;
determining whether said user is authorized to view data about a second aspect of the industrial process that is directly related to the first aspect of the industrial process;
generating an inactive informational display item when it is determined said user is not authorized to view the data about the second aspect of the industrial process and displaying the informational display item in the first view, the informational display item providing a visual indication of the relationship between the first aspect of the industrial process and the second aspect of the industrial process and being non-selectable for navigating to another display; and
generating an active navigational display item when it is determined said user is authorized to view the data about the second aspect of the industrial process and displaying the navigational display item in the first view, the navigational display item providing a visual indication of the relationship between the first aspect of the industrial process and the second aspect of the industrial process and being selectable for navigating to a second view including the data about the second aspect of the industrial process.
